(19) United States
(12) Patent Application Publication
(10) Pub. No.: US 2016/0142505 A1
(43) Pub. Date: May 19, 2016

(54) METHOD AND APPARATUS FOR PROCESSING MESSAGE

(71) Applicant: Samsung Electronics Co., Ltd., Suwon-si (KR)

(72) Inventors: Kwangsub KIM, Yongin-si (KR); Daesung KIM, Suwon-si (KR); Jungjik LEE, Suwon-si (KR); Kyungtae KIM, Suwon-si (KR); Sungmin YOON, Suwon-si (KR); Pyeonggyu JIN, Suwon-si (KR)

(21) Appl. No.: 14/936,040

(22) Filed: Nov. 9, 2015

(30) Foreign Application Priority Data
Nov. 17, 2014 (KR) 10-2014-0160197

(51) Int. Cl. H04L 29/08; H04L 29/06

(52) U.S. Cl. CPC H04L 67/26; H04L 67/42

(57) ABSTRACT

An apparatus for processing a message is provided. The apparatus includes a message controller configured to check contents included in a push message, determine a template of the push message in relation to the contents, and generate a content message by using the contents and the template, and a message communication unit configured to receive the push message from a service server, and transmit the content message to an electronic device.

### CROSS-REFERENCE TO RELATED APPLICATION(S)

This application claims the benefit under 35 U.S.C. §119(a) of a Korean patent application filed on Nov. 17, 2014 in the Korean Intellectual Property Office and assigned Serial number 10-2014-0160197, the entire disclosure of which is hereby incorporated by reference.

### TECHNICAL FIELD

The present disclosure relates to a method of efficiently processing a message.

### BACKGROUND

With the development of information communication technology and semiconductor technology, the spread and use of electronic devices is rapidly increasing. Electronic devices have provided primary services, such as voice communication and text message transmission. But recently, the electronic device also provides a wireless Internet environment, as well as photographing, navigation, and payment, thereby providing various services.

In order to provide various services, an application providing each service according to a selection of a user is installed in the electronic device. A service server providing each application provides information associated with an application by a push method. A technology that provides information by the push method is referred to as a “push messaging technology”. The push messaging technology in the related art may be a technology, in which a service server is one-to-one connected with an application, so that the service server directly transmits a push message to an electronic device, in which the application is installed. To this end, the service server and the electronic device need to maintain a keep-alive state so as to transmit and receive a push message. However, when a packet is not transmitted and received for a predetermined time or longer in the connection state, a mobile communication provider determines a current state to be an idle state and removes an idle connection. Accordingly, in order to maintain the keep-alive state, a connection maintenance client and the service server periodically transmit small amount of packets so that the electronic device may maintain the connection. That is, the connection maintenance client enables the electronic device to receive a push message from the service server in a state where the electronic device does not execute an application.

The above information is presented as background information only to assist with an understanding of the present disclosure. No determination has been made, and no assertion is made, as to whether any of the above might be applicable as prior art with regard to the present disclosure.

### SUMMARY

However, in order to receive a push message, a user needs to install an application in an electronic device. That is, the push messaging technology in the related art may only provide a push message to an application installed in the electronic device. Further, a user needs to agree with the reception of a push message for each application. That is, the user needs to individually agree with a reception of a first push message for a first application, and also individually agree with a reception of a second push message for a second application.

Further, in the push messaging technology in the related art, in order to receive push messages for ten applications, the applications need to be one-to-one connected with ten service servers. That is, the first application may only receive a push message transmitted by a first service server, and the second application may only receive a push message transmitted by a second service server. However, since the electronic device has a limited hardware specification, it is difficult to guarantee that a connection maintenance client within the electronic device is always activated. Further, the push message received once is displayed on the electronic device, and when a predetermined time elapses, the push message disappears regardless of a user's confirmation. Further, since the push message includes simple information, such as a uniform resource locator (URL), an image, and text, a user easily determines the push message to be smishing or an illegal site.

Aspects of the present disclosure are to address at least the above-mentioned problems and/or disadvantages and to provide at least the advantages described below. Accordingly, an aspect of the present disclosure is to provide a server and a method for processing a push message, which generate a content message by converting push messages provided by a plurality of service servers into a form having excellent visibility for a user to induce high user interaction.

Another aspect of the present disclosure is to provide a method and an electronic device for processing a push message, which enable one content message to be shared by a plurality of applications by dynamically relating the content message with the plurality of applications.

In accordance with an aspect of the present disclosure, an apparatus for processing a message is provided. The apparatus includes a message controller configured to check contents included in a push message, determine a template of the push message in relation to the contents, and generate a content message by using the contents and the template, and a message communication unit configured to receive the push message from a service server, and transmit the content message to an electronic device.

In accordance with another aspect of the present disclosure, an electronic device is provided. The electronic device includes a display unit configured to display a content message, and a processor configured to identify an application action related to the content message, control the content message and the identified application action to be displayed on the display unit, and execute an application action selected by a user.

In accordance with another aspect of the present disclosure, a method of processing a message by a message processing apparatus is provided. The method includes checking contents included in a push message received from a service server, determining a template of the push message based on the contents, generating a content message by using the contents and the template, and transmitting the content message to an electronic device.

In accordance with another aspect of the present disclosure, a method of processing a message by an electronic apparatus is provided. The method includes identifying an application action related to a content message, displaying the content message and the identified application action, and executing an application action selected by a user.

According to various embodiments of the present disclosure, the present disclosure may be 1:N connected with a plurality of service servers to receive a plurality of push messages at once.

According to various embodiments of the present disclosure, the present disclosure may convert a received push message into a form having excellent visibility for a user and displaying a content message, thereby inducing high user interaction.

According to various embodiments of the present disclosure, the present disclosure may store the received content message in a storage unit, thereby enabling a user to check a content push message later.

According to various embodiments of the present disclosure, the present disclosure dynamically relates a plurality of applications to a content message, thereby enabling the plurality of applications to share one content message.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a network connection relation between a service server, a message processing server, and an electronic device according to various embodiments of the present disclosure;

FIGS. 2A, 2B, 2C, and 2D are flowcharts illustrating a method of processing a message between a service server, a message processing server, and an electronic device according to various embodiments of the present disclosure;

FIG. 3 is a block diagram illustrating a configuration of a message processing server according to various embodiments of the present disclosure;

FIG. 4 is a diagram illustrating generation of a content message by the message processing server according to various embodiments of the present disclosure;

FIG. 5 is a flowchart illustrating a method of processing a push message by the message processing server according to various embodiments of the present disclosure;

FIG. 6 is a block diagram illustrating a configuration of an electronic device according to various embodiments of the present disclosure;

FIG. 7 is a flowchart illustrating a method of processing a push message by an electronic device according to various embodiments of the present disclosure;

FIGS. 8A and 8B are diagrams illustrating a content message according to various embodiments of the present disclosure; and

FIGS. 9A, 9B, and 9C are diagrams illustrating generation and display of a content message by using a push message according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the spirit and scope of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to various embodiments of the present disclosure, the electronic device may include devices having an operation support function. Examples of the electronic device may include smartphone, table personal computer (PC), mobile phone, video phone, electronic book (e-book) reader, desktop PC, laptop PC, netbook computer, personal digital assistant (PDA), portable multimedia player (PMP), Moving Picture Experts Group phase 1 or phase 2 (MPEG-1 or MPEG-2) audio layer 3 (MP3) player, mobile medical appliance, camera, wearable device (e.g., head-mounted device (HMD) such as electronic glasses, electronic clothing, electronic bracelet, electronic necklace, electronic appcessory, electronic tattoo, smartwatch, etc.

According to an embodiment of the present disclosure, the electronic device may be one of smart home appliances having operation support function. Examples of the smart electronic appliance as an electronic device may include television (TV), digital versatile disc (DVD) player, audio player, refrigerator, air-conditioner, vacuum cleaner, electronic oven, microwave oven, laundry machine, air cleaner, set-to box, TV box (e.g., Samsung HomeSync™, Apple TV™, and Google TV™), game console, electronic dictionary, electronic key, camcorder, and electronic frame, etc.

According to an embodiment of the present disclosure, examples of the electronic device may include medical device (e.g., magnetic resonance angiography (MRA), magnetic resonance imaging (MRI), computed tomography (CT)), navigation device (ND), global positioning system (GPS) receiver, event data recorder (EDR), flight data recorder (FDR), car infotainment device, maritime electronic device (e.g., maritime navigation device and gyro compass), aviation electronic device (avionics), security device, vehicle head unit, industrial or home robot, automatic teller's machine (ATM) of financial institution, point of sales (POS), etc.

According to various embodiments of the present disclosure, the electronic device may include at least one of furniture or a part of a building/structure, an electronic board, an electronic signature receiving device, a projector, and various types of measuring devices (for example, a water meter, an electricity meter, a gas meter, a radio wave meter and the like) including a projection function. The electronic device according to various embodiments of the present disclosure may be one or a combination of the above described various devices. Further, the electronic device according to various embodiments of the present disclosure may be a flexible device. It is apparent to those skilled in the art that the electronic device according to various embodiments of the present disclosure is not limited to the above described devices.

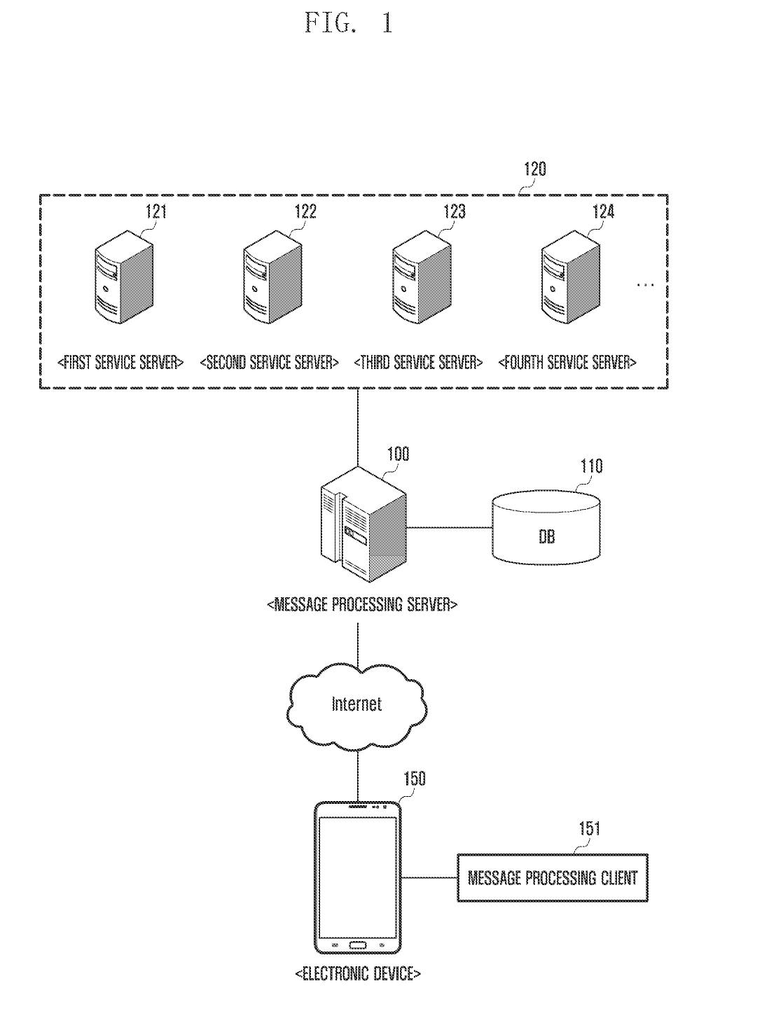

FIG. 1 is a diagram illustrating a network connection relation between a service server, a message processing server, and an electronic device according to various embodiments of the present disclosure.

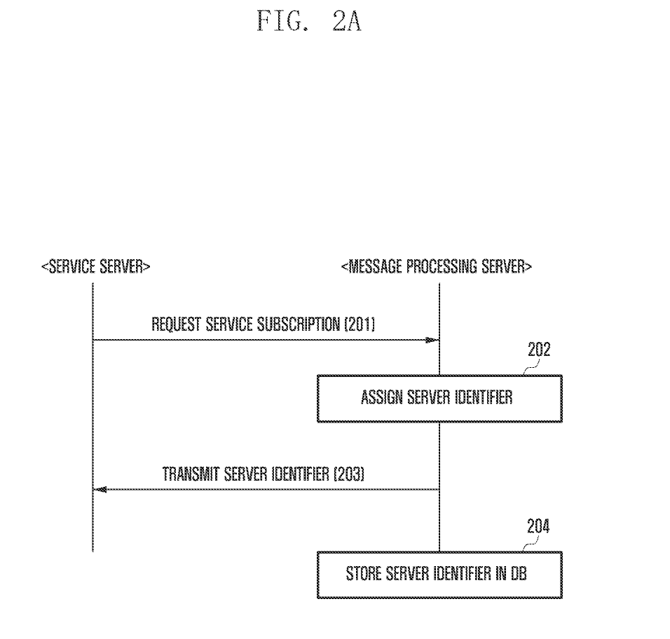

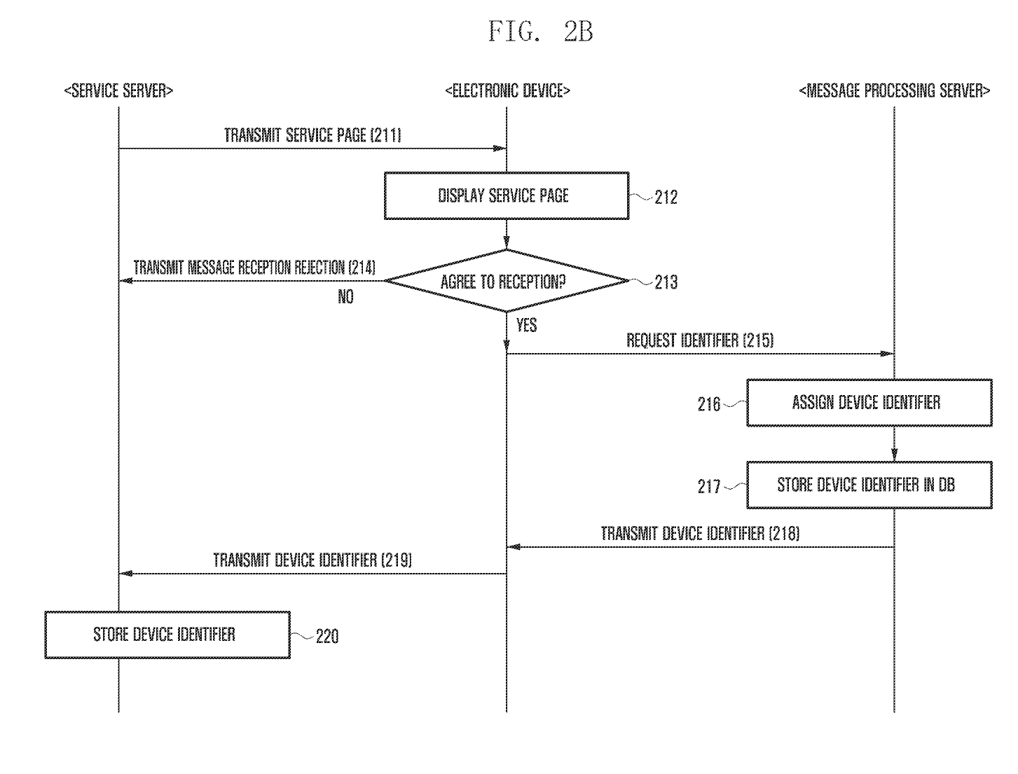

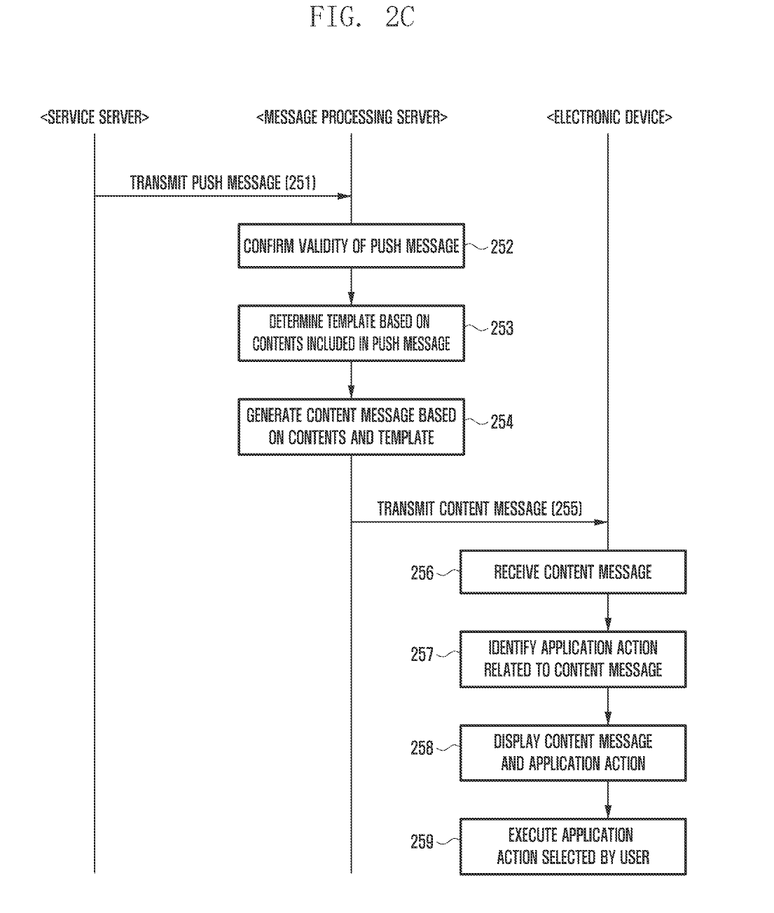

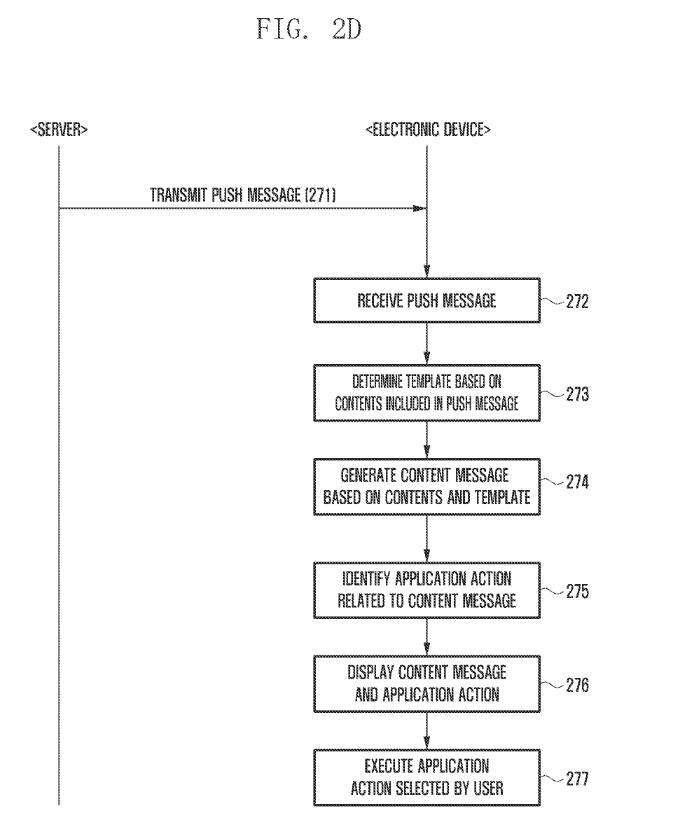

FIG. 2A is a flowchart illustrating assignment of a server identifier according to various embodiments of the present disclosure.

Referring to FIGS. 1 and 2A, in operation 201, a service server 120 may request the subscription of a service from a message processing server 100 (or a message processing device). The service server 120 may be a server providing various elements of information related to an application in a form of a push message. Hereinafter, the service server 120 collectively means a first service server 121 to a fourth service server 124.

In the related art, the service server 120 is one-to-one connected to applications installed in an electronic device 150 to provide a push message, but in the present disclosure, the message processing server 100 is one-to-N connected to the plurality of service servers 121 to 124 and appropriately processes push messages transmitted by the plurality of service servers 121 to 124 to transmit the provided push messages to the electronic device 150. In order to transmit the push message received from the service server 120 to the electronic device 150, the message processing server 100 needs to assign a service identifier capable of identifying the service server 120 and a device identifier capable of identifying the electronic device 150.

When the service subscription is requested from the service server 120, the message processing server 100 may assign a server identifier for the service server 120 in operation 202. The service subscription request may be a request for the transmission of a push message to the electronic device 150 through the message processing server 100 unlike the related art. For example, the message processing server 100 may assign a server identifier of “A01” for the first service server 121, a server identifier of “A02” for the second service server 122, a server identifier of “A03” for the third service server 123, and a server identifier of “A04” for the fourth service server 124. In operation 203, the message processing server 100 may transmit the assigned server identifiers to the service server 120. In operation 204, the message processing server 100 may store the server identifier assigned for each server in a database 110.

FIG. 2B is a flowchart illustrating assignment of a device identifier according to various embodiments of the present disclosure.

Referring to FIGS. 1 and 2B, the electronic device 150 may agree with the reception of the push message in advance. In operation 211, the service server 120 may include the server identifier, and transmit a service page capable of agreeing with the reception of the push message to the electronic device 150.

In operation 212, the electronic device 150 may display the service page on a screen. In operation 213, the electronic device 150 may determine whether a user agrees with the reception of the push message through the service page. When the user does not agree with the reception of the push message, in operation 214 the electronic device 150 may transmit a rejection of the reception of the push message to the service server 120. In this case, the electronic device 150 may include a message processing client 151 for processing the transmission/reception of the push message. When the user agrees with the reception of the push message, the electronic device 150 may request a unique identifier of the user from the message processing server 100 in operation 215. The unique identifier of the user may be a “device identifier” capable of identifying an electronic device to receive the push message.

In operation 216, the message processing server 100 may assign a device identifier to the electronic device 150. In operation 217, the message processing server 100 may store the device identifier assigned for each electronic device in the database 110. In operation 218, the message processing server 100 may transmit the assigned device identifiers to the electronic device 150.

In operation 219, the electronic device 150 may receive the device identifier, and transmit the received device identifier to the service server 120. The electronic device 150 may also store the device identifier in a storage unit.

In operation 220, the service server 120 may store the device identifier.

For reference, the flowcharts of FIGS. 2A and 2B may describe a pre-processing process for performing a method of processing a message of FIGS. 2C and 2D.

FIG. 2C is a flowchart illustrating a method of processing a message between the service server, the message processing server, and the electronic device according to various embodiments of the present disclosure.

Referring to FIGS. 1 and 2C, in operation 251, the service server 120 may transmit a push message. The push message may include a server identifier, a device identifier, and contents. The contents may include information related to the application, for example, a uniform resource locator (URL), text, an image, a video, a file, a map-POI, a calendar, and an alarm.

The service server 120 may have one service server in correspondence with one application or one service server in correspondence with a plurality of applications. In the description below, one service server is matched to one application to provide a push message. However, contents of the present disclosure are not limited by the description. For example, the first service server 121 may provide the first push message related to the first application (for example, shopping), the second service server 122 may provide the second push message related to the second application (for example, a game), the third service server 123 may provide a third push message related to a third application (for example, chatting), and the fourth service server 124 may provide a fourth push message related to a fourth application (for example, a social network service).

In operation 252, the message processing server 100 may receive the push message, and confirm the validity of the push message. For example, the message processing server 100 may determine validity of the push message by determining whether the server identifier and the device identifier included in the push message are the same as those stored in the database 110.

When the validity is confirmed, the message processing server 100 may determine a template based on the contents included in the push message in operation 253. As described above, the contents includes a URL, text, an image, a video, a file, a map point of interest (map-POI), a calendar, and an alarm, so that the message processing server 100 may determine the template in accordance with the contents. Here, the template may be a basic form of a content message to be newly generated. In operation 254, the message processing server 100 may generate a content message based on the contents and the template. The content message may be a message newly generated by the message processing server 100 based on the push message.

For example, when only a URL is included in the push message, and the push message is provided to the electronic device 150 as it is, the user may also determine the push message including only the URL to be smishing or an illegal site. Further, when the push message includes only simple text or image, the simple text or image is insufficient to attract the attention of the user. In order to supplement the disadvantage, the message processing server 100 needs to convert original contents of the push message into a form attracting an attention of the user and generate a message with improved visibility for a user without considerably changing the original contents of the push message. The message generated according to the necessity is the content message. In operation 255, the message processing server 100 may transmit the contents message to the electronic device 150 corresponding to the device identifier included in the push message.

In operation 256, the electronic device 150 may receive the content message. In operation 257, the electronic device 150 may identify an application action related to the content message. The application action may be one or more functions executable in relation with the content message. In operation 258, the electronic device 150 may display the content message and the identified application action. The user may select one or more application actions while viewing the content message. In operation 259, the electronic device 150 may execute the application action selected by the user.

FIG. 2D is a flowchart illustrating a method of processing a message between a server and an electronic device according to various embodiments of the present disclosure.

Referring to FIGS. 1 and 2D, in operation 271, a server may transmit a push message to the electronic device 150. Here, the server may be the service server 120 or the message processing server 100. Hereinafter, it is described based on that the server is the message processing server 100, but the server is not limited to the message processing server 100 by the description. The message processing server 100 may receive a push message from the service server 120, and store the received push message in the database 110. The message processing server 100 may store the push messages for a predetermined time period (for example, one day, a week, a half month, or a month) in the database 110, and then transmit the push messages stored up to the present to the electronic device 150 at once. For example, the message processing server 100 may transmit the push messages to the electronic device 150 when a request is made from the electronic device 150 or at a date (for example, one day, a week, or a half month) preset by the electronic device 150.

The message processing server 100 may confirm the validity for the push message before transmitting the push message. For example, the message processing server 100 may confirm validity of the push message by determining whether a server identifier and a device identifier included in the push message are the same as those stored in the database 110. When the validity is confirmed, the message processing server 100 may transmit the push message to the electronic device 150 corresponding to the device identifier included in the push message. In this case, the message processing server 100 may process the push message to delete the server identifier and the device identifier from the push message and insert only contents into the push message. The push message may not include the server identifier and the device identifier, but may include only the contents. In some embodiments, the server identifier or the device identifier may be for the purpose of confirming the validity of the message. Since the message processing server 100 has already confirmed the validity of the push message, the message processing server 100 may not need to transmit the server identifier and the device identifier.

In operation 272, the electronic device 150 may receive the push message.

In operation 273, the electronic device 150 may determine a template based on the contents included in the push message. The electronic device 150 may confirm the contents included in the push message. As described above, the contents include a URL, text, an image, a video, a file, a map-POI, a calendar, an alarm, and the like, so that the electronic device 150 may determine the template in accordance with the contents. Here, the template may be a basic form of a content message to be newly generated.

In operation 274, the electronic device 150 may generate a content message based on the contents and the template. The content message may be a message newly generated by the electronic device 150 based on the push message.

In operation 275, the electronic device 150 may identify an application action related to the content message. The application action may be at least one function executable in relation to the content message. In operation 276, the electronic device 150 may display the content message and the identified application action. A user may view the content message, and select at least one application action. In operation 277, the electronic device 150 may execute the application action selected by the user.

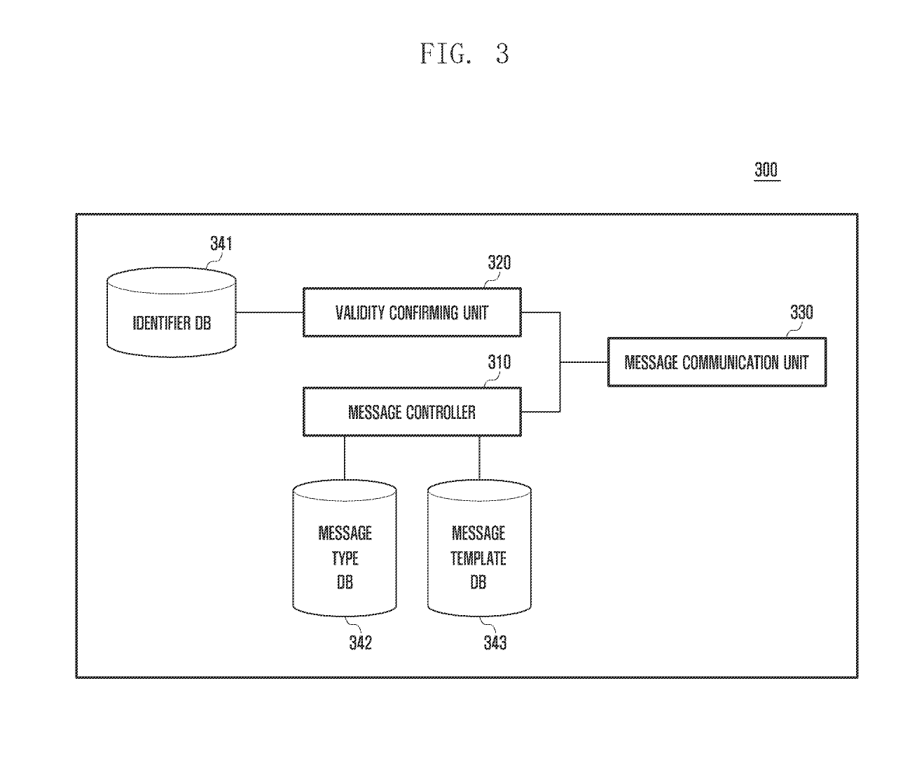

FIG. 3 is a block diagram illustrating a configuration of a message processing server according to various embodiments of the present disclosure.

Referring to FIG. 3, a message processing server (or a message processing device) 300 may include a message controller 310, a validity confirming unit 320, a message communication unit 330, an identifier database 341, a message-type database 342, and a message template database 343.

The message controller 310 may control a general operation of the message processing server 300 and a signal flow between internal elements of the message processing server 300, and processes data. The message controller 310 may be a processor. When the message controller 310 receives a request from the service server, the message controller 310 may assign a server identifier to the service server. When the message controller 310 receives a request from an electronic device, the message controller 310 may assign a device identifier to the electronic device. The request may be a desire to transmit and receive a push message through the message processing server 300.

The message controller 310 may confirm contents included in a push message received from the service server through the message communication unit 330. The contents may be at least one of a URL, text, an image, a video, a file, a map-POI, a calendar, an alarm, and the like. The message controller 310 may determine a template of the push message based on the contents. The template may be a basic form of a content message to be newly generated in accordance with the contents. The message controller 310 may generate a content message based on the contents and the template. The content message may be a message newly generated by the message processing server 300 based on the push message.

According to various embodiments of the present disclosure, the message controller 310 may store the received push message in a database. Here, the database may be a message type database 342 or a message template database 343, and be another database (not shown). The database may store a push message for each device identifier or a server identifier. The message controller 310 may store the push messages for a predetermined time period (for example, one day, a week, a half month, or a month) in the database, and then transmit the push messages stored up to the present to the electronic device 150 at once through the message communication unit 330. For example, the message controller 310 may control the push messages to be transmitted to the electronic device 150 when a request is made from the electronic device 150 or at a date (for example, one day, a week, or a half month) preset by the electronic device 150. In this case, the message controller 310 may process the push message so that the server identifier and the device identifier originally included in the push message are deleted, and only the contents are included in the push message. The content message 420 has better visibility than the push message 410, and may improve the interaction of a user. Here, visibility may be easy confirmation of approximate contents of a message through a displayed image or text compared to the push messages 410 simply numerated with text or URLs. The interaction of the user may be the performance of a specific function related to the content message, such as storing or sharing the content message.

The validity confirming unit 320 may confirm validity of the push message. As the method of confirming the validity, a quarter check, an abuse check, a valid identifier check and the like may be used. Hereinafter, the method of confirming the validity will be described based on a valid identifier check as an example, but the method of confirming the validity is not limited to a valid identifier check. The push message may include information about a server identifier, a device identifier, and an application. The validity confirming unit 320 may determine whether the server identifier and the device identifier included in the push message are the same as those stored in the identifier database 341. When the server identifier and the device identifier included in the push message are the same as those stored in the identifier database 341, the validity confirming unit 320 may determine that the push message is valid.

FIG. 3 illustrates that the message controller 310 is separated from the validity confirming unit 320, but the validity confirming unit 320 may be included in the message controller 310.

The message communication unit 330 may perform data communication with the service server and the electronic device through a network under the control of the message controller 310. The message communication unit 330 may receive the push message from the service server, and transmit the received push message to the validity confirming unit 320. The message communication unit 330 may receive the push message or the content message from the message controller 310 and transmit the received push message or content message to the electronic device.

The identifier database 341 may store a server identifier for each service server and a device identifier for each electronic device. The message type database 342 may store information for analyzing a message type. Information for each message type may be stored in the message type database 342. The message template database 343 may store a basic form of a message for each message type. The template may be different according to the message type, and message template database 343 may include one or more templates for one message type.

FIG. 3 illustrates that the identifier database 341, the message type database 342, and the message template database 343 are separated from each other, but the identifier database 341, the message type database 342, and the message template database 343 may be configured as one database.

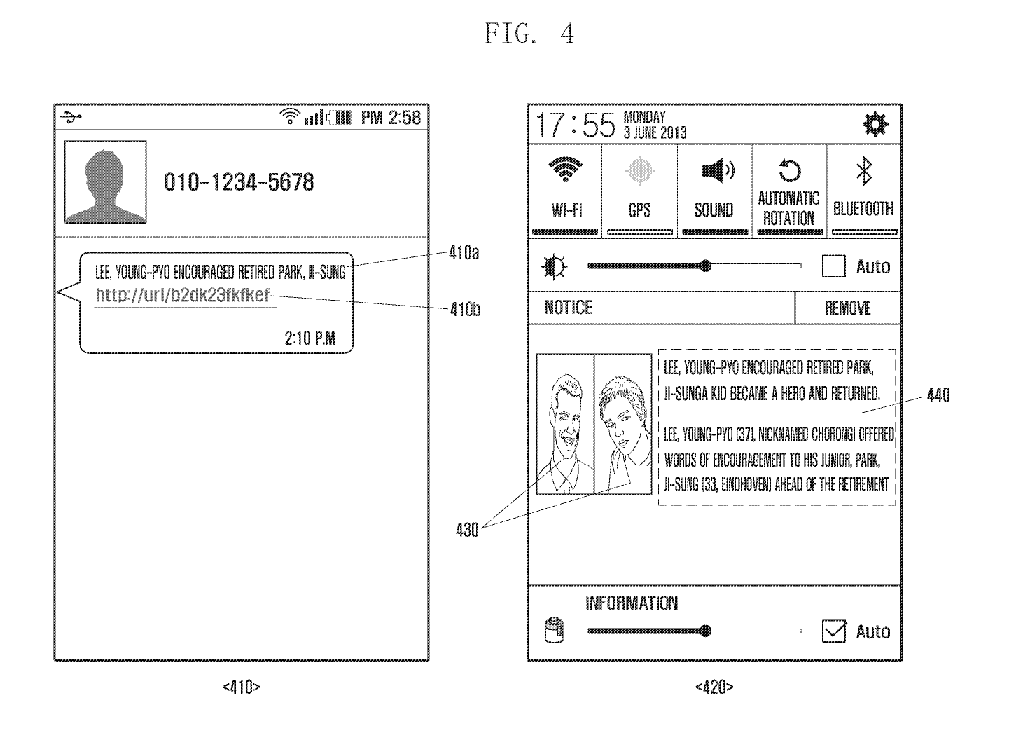

FIG. 4 is a diagram illustrating generation of a content message by the message processing server according to various embodiments of the present disclosure.

Referring to FIGS. 3 and 4, reference numeral 410 of FIG. 4 illustrates a push message received from the service server. The push message 410 includes only text (LEE, Young-Pyo encouraged retired PARK, Ji-Sung . . . ) denoted by reference numeral 410a and a URL (http://url/b2dk23fkfkef) denoted by reference numeral 410b. When the push message is provided to the electronic device as it is, only the URL is included in the push message, so that a user may also determine the push message to be smishing or an illegal site. Accordingly, the message controller 310 may generate a content message denoted by reference numeral 420 by using the push message 410. The message controller 310 may parse an image 430 and text 440 (LEE, Young-Pyo (37), nicknamed chorongi . . . to his junior, PARK, Ji-Sung (33, Eindhoven) ahead of the retirement) from the URL based on the contents included in the push message and a template in accordance with the contents. The message controller 310 may generate the content message 420 by appropriately processing the parsed image and text in accordance with the contents and the template.

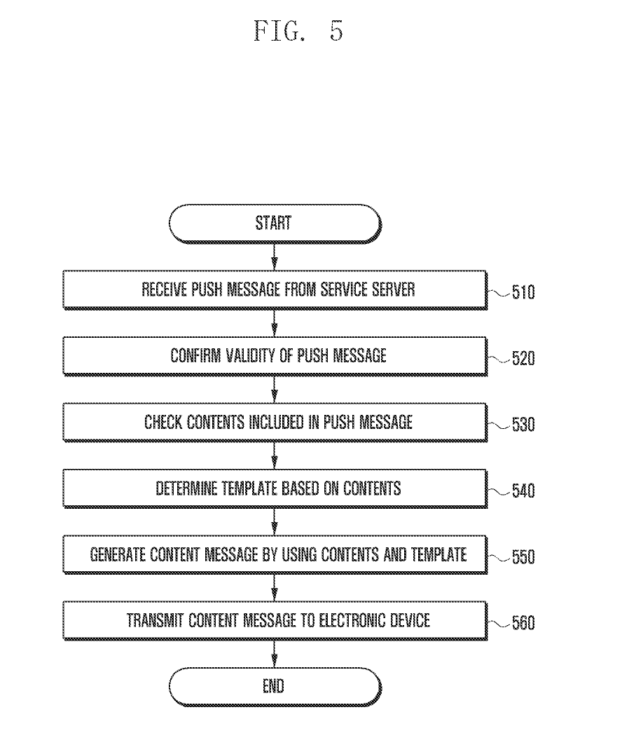

FIG. 5 is a flowchart illustrating a method of processing a push message by the message processing server according to various embodiments of the present disclosure.

Referring to FIGS. 3 and 5, in operation 510, the message communication unit 330 may receive the push message from the service server in real time. The push message may include information about a server identifier, a device identifier, and contents. The contents may include information related to the application, for example, a URL, text, an image, a video, a file, a map-POI, a calendar, an alarm, and the like. The message communication unit 330 may transmit the received push message to the validity confirming unit 320.

In operation 520, the validity confirming unit 320 may confirm validity of the push message. In order for the message processing server 300 to process the push message, generate the processed push message into a content message, and then provide the generated content message to the electronic device, a process of assigning a server identifier to the service server and assigning a device identifier to the electronic device needs to be proceeded. In this case, the message controller 310 may store the assigned server identifier and device identifier to the identifier database 341. Then, when the push message is received, the validity confirming unit 320 may determine whether the server identifier and the device identifier included in the push message are the same as those stored in the identifier database 341. When the validity of the push message is confirmed, the validity confirming unit 320 may notify the message controller 310 of the confirmed validity of the push message.

In operation 530, when the push message is valid, the message controller 310 may confirm a message type of the push message. The message type may be at least one of an image type, a URL type, a map type, a schedule type, and a text type. The message controller 310 may compare the information stored in the message type database 342 and the information (the information about the application) included in the push message to confirm the message type. Information for each message type is stored in the message type database 342. The message controller 310 may confirm whether a message type of information, which is the same as or similar to the information included in the push message, exists in the message type database 342.

For example, when the information is a schedule (for example, a weather and a place), the message controller 310 may determine a message type of information stored in the message type database 342 matched with the date and the place as a schedule type. When the information is a URL, the message controller 310 may determine a message type of information stored in the message type database 342 matched with the URL as a URL type.

In operation 540, the message controller 310 may determine a template based on the message type. In this case, the message controller 310 may determine the template based on the message type and the information included in the push message. The template may be a basic form of a content message to be newly generated in accordance with the message type. For example, the template may include an image in a left area and text related to the image in a right area. By contrast, the template may include an image in a right area, and text related to the image in a left area. Otherwise, the template may include text in an upper area, and an image in a lower area. An opposite case thereof is available. Otherwise, the template may include an image in a background, and text related to the image on the image.

In operation 550, the message controller 310 may generate a content message based on the push message and the template. For example, when the image and the text are included in the push message, the message controller 310 may insert the image into the left area of the template and insert the text into the right area to generate a content message as denoted by reference numeral 420 of FIG. 4. The message processing server may generate the contents message having excellent visibility and induce a high interaction without considerably changing original contents of the push message received from the service server in real time. When the content message is completely generated, the message controller 310 may transmit the generated content message to the message communication unit 330.

In operation 560, the message communication unit 330 may transmit the content message to the electronic device.

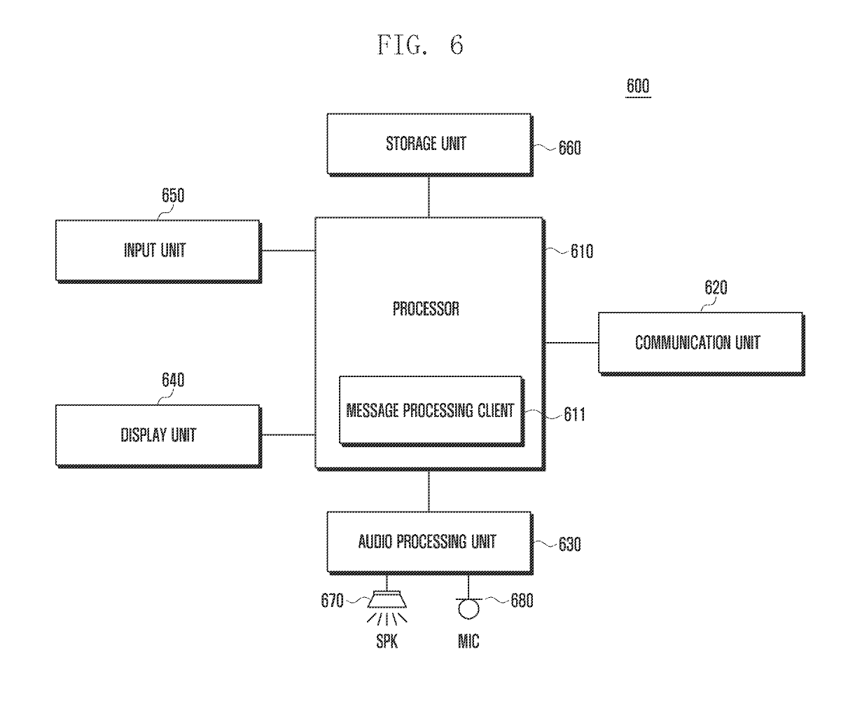

FIG. 6 is a block diagram illustrating a configuration of an electronic device according to various embodiments of the present disclosure.

Referring to FIG. 6, an electronic device 600 may include a processor 610, a communication unit 620, an audio processing unit 630, a display unit 640, an input unit 650, and a storage unit 660.

The processor 610 controls a general operation of the electronic device 600 and a signal flow between internal elements of the electronic device 600, performs a function of processing data, and controls power supply from a battery to the elements. The processor 610 may include a central processing unit (CPU) and a graphics processing unit (GPU). Meanwhile, the CPU is a core control unit of a computer system that performs calculations and comparisons of data, the interpretation and execution of instructions, and the like. The GPU is a graphic control unit that performs calculations and comparisons of graphic-related data, and the interpretation and execution of instructions, and the like. Each of the CPU and the GPU may be integrated into one package in which two or more independent cores (for example, quad-core) form a single integrated circuit. The CPU and the GPU may be a system on chip (SoC). Further, the CPU and the GPU may be packaged as a multi-layer. Meanwhile, a configuration including the CPU and the GPU may be referred to as an “application processor (AP).”

When battery power is supplied to the processor 610, a booting program may first be loaded to a main memory. The booting program may load an operating system to the main memory. The operating system may load an application to the main memory. The processor 610 may decipher a command (routine) of a program by accessing the main memory, and may execute a function according to a result of the decipherment. The application may include, for example, a short message service (SMS)/multimedia message service (MMS) application, a social network service (SNS) application, an e-mail application, a calendar application, an alarm application, or an environment information application (for example, an application providing information on atmospheric pressure, humidity, or a temperature). Additionally, the application may include an application for receiving various information from an external device. The application may provide, for example, a function of periodically receiving a really simple syndication (RSS) feed (for example, news, and a bulletin board message of a blog) from an information providing server. Further, the information receiving application may provide a function of periodically receiving a wallpaper from the information providing server.

The processor 610 may include a message processing client 611. The processor 610 may identify an application action associated with the content message through the message processing client 611. The application action may be at least one function executable in relation to the content message. For example, the processor 610 may identify the application action related to the content message based on at least one of the information included in the content message, the application installed in the electronic device 600, and a user's application use pattern. The processor 610 may execute the application action selected by the user among the identified application actions.

According to various embodiments of the present disclosure, the processor 610 may determine a template based on the contents included in the push message. The contents may include information related to the application. For example, the contents may include a URL, text, an image, a video, a file, a map-POI, a calendar, an alarm, and the like. The processor 610 may confirm the contents included in the push message. The processor 610 may determine the template in accordance with the contents. Here, the template may be a basic form of a content message to be newly generated. The processor 610 may generate a content message based on the contents and the template. The content message may be a message newly generated by the processor 610 based on the push message.

The communication unit 620 may receive the content message from the message processing server. The communication unit 620 may perform voice call, video call, or data communication with an external device through a network under the control of the processor 610. The communication unit 620 includes a wireless frequency transmitter for up-converting and amplifying a frequency of a transmitted signal, and a wireless frequency receiver for down-converting and low-noise amplifying a frequency of a received signal. The communication unit 620 may include a cellular module (for example, a communication module providing voice call, video call, text message service, or the Internet service through a communication network (for example, long-term evolution (LTE), LTE-advanced (LTE-A), code division multiple access (CDMA), wideband CDMA (WCDMA), universal mobile telephone system (UMTS), wireless broadband (WiBro), or global system/standard for mobile communication (GSM)), a digital broadcast module (for example, a digital multimedia broadcasting (DMB) module), and a short range communication module (for example, a Wi-Fi module, a Bluetooth module, and a near field communication (NFC) module).

The audio processing unit 630 may output a voice related to the content message or a voice related to the executed application action. The audio processing unit 630 may output the voice under the control of the processor 610. The audio processing unit 630 may be combined with a speaker SPK 670 and a microphone MIC 680 to input and output an audio signal (for example, voice data) for a voice recognition, a voice recording, a digital recording, and a call. The audio processing unit 630 receives an audio signal from the microphone or the communication unit 620, and a digital-to-analog converter (D/A) converts the received audio signal to an analog signal, amplifies the converted signal, and outputs the amplified signal through the speaker SPK 670. The speaker SPK 670 converts the received audio signal into a sound wave and outputs the sound wave. The microphone MIC 680 converts a sound wave transmitted from a human or another sound source to an audio signal.

The display unit 640 may display the content message and the identified application action. The display unit 640 displays an image on a screen under the control of the processor 610. When the processor 610 processes (for example, decodes) data into an image to be displayed on the screen and stores the processed image in a buffer, the display unit 640 converts the image stored in the buffer into the analog signal and displays the converted analog signal on the screen. The display unit 640 may be formed of a liquid crystal display (LCD), organic light emitting diode (OLED), an active matrix OLED (AMOLED), or a flexible display.

The input unit 650 may receive an input of selecting the application action from the user. The input unit 650 may include a plurality of keys for receiving numeric or text information and setting various functions. The keys may include a menu opening key, a screen on/off key, a power on/off key, a volume control key, and the like. The input unit 650 generates a key event related to user's setting and the control of the function of the electronic device 600 and transmits the generated key event to the processor 610. The key event may include a power on/off event, a volume control event, a screen on/off event, a shutter event, and the like. The processor 610 controls the aforementioned elements in response to the key event. Meanwhile, keys of the input unit 650 may be referred to as hard keys, and virtual keys displayed on the display unit 640 may be referred to as soft keys.

According to various embodiments of the present disclosure, the display unit 640 and the input unit 650 may be an integrally formed touch screen.

The storage unit 660 may store the content message. The storage unit 660 stores data (for example, an SMS, an MMS, an SNS message, and an e-mail) generated by the electronic device 600 or received from an external device through the communication unit 620 under the control of the processor 610. Further, the storage unit 660 stores a booting program, and one or more operating systems and applications. Further, the storage unit 660 may store various setting information (for example, screen brightness and elements of a lock screen) for setting a use environment of the electronic device 600. Accordingly, the processor 610 may operate the electronic device 600 with reference to the setting information.

The storage unit 660 may include a main memory and a secondary memory. The main memory may be implemented by, for example, a random access memory (RAM). The secondary memory may be implemented by a disk, a RAM, a read only memory (ROM), or a flash memory. The main memory may store various programs, for example, the booting program, the operating system (for example, a kernel), middleware, an application programming interface (API), and an application, loaded from the secondary memory. The storage unit 660 may also further include an external memory. For example, the storage unit 660 may further include compact flash (CF), secure digital (SD), micro-SD, mini-SD, extreme digital (xD), or a memory stick as the external memory.

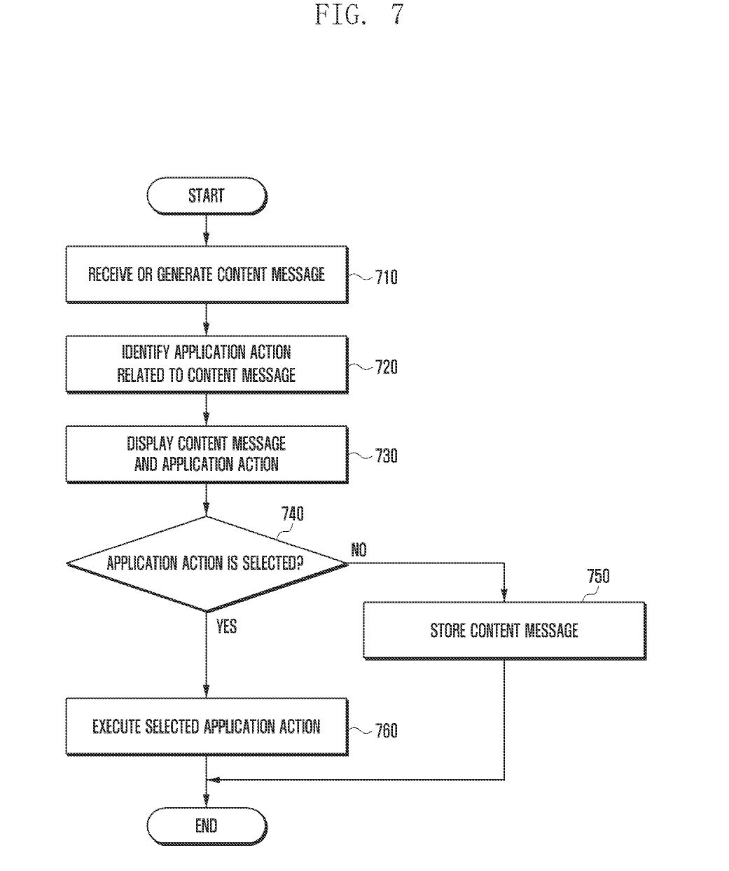

FIG. 7 is a flowchart illustrating a method of processing a push message by the electronic device according to various embodiments of the present disclosure.

Referring to FIGS. 6 and 7, in operation 710, the processor 610 may receive a content message from the message processing server through the communication unit 620 or generate a content message. The content message is a message received in real time from the service server and processed. The processor 610 may determine a template based on contents included in the push message. The contents may include information related to the application. The processor 610 may confirm the contents included in the push message, and determine the template in accordance with the confirmed contents. The processor 610 may generate a content message based on the contents and the template. According to the present disclosure, the content message may also be received from the message processing server, but may also be directly generated by the electronic device 600.

In operation 720, the processor 610 may identify an application action related to the content message. The application action may be at least one function executable in relation to the content message. For example, the application action may be at least one of execution, storage, edit, sharing, copy, delete, and read later. For example, the processor 610 may identify the application action related to the content message based on at least one of the information included in the content message, the application installed in the electronic device 600, and a user's application use pattern.

For reference, in the related art, only an application statically set in one application may be executed, but in the present disclosure, the application action may be dynamically varied. Particularly, in the present disclosure, the application action is different according to the information included in the content message, the application installed in the electronic device 600, and the user's application use pattern. For example, when a “map” is included in the content message, only a designated map application is shared in the related art, but the processor 610 may enable all of the applications executable in relation to the map to share the content message. Otherwise, when a “schedule” is included in the content message, only a designated schedule application is shared in the related art, but the processor 610 may enable all of the applications executable in relation to the schedule to share the content message.

The information included in the content message includes various types of information, such as text, an image, a video, a URL, a map, and a schedule. The processor 610 may identify the application action according to the information included in the content message. The processor 610 may identify the application action preferentially considering the application installed in the electronic device 600. However, when a use possibility of an application, which is not installed in the electronic device 600, is high in relation to the information included in the content message or the service server had recommended an application, which is not installed in the electronic device 600, the processor 610 may also identify the application as the application action. In this case, the processor 610 may download the application according to a selection of the user and then execute the application.

Further, the user's application use pattern may include the number of times of use for each application for a predetermined time and information about an application, which has been interworked before. For example, in a case where the user mainly uses an application, such as “OO calendar”, a “housekeeping book”, and a “calculator” in relation to a “schedule”, when the information included in the content message is a schedule, the processor 610 may identify the “OO calendar”, the “housekeeping book”, and the “calculator” as the application actions.

In operation 730, the processor 610 may control the content message and the identified application action to be displayed on the display unit 640. When the processor 610 receives a content message display request from the user, the processor 610 may control the content message and the identified application action to be displayed. The content message display request may be a gesture moving from a bezel portion to the display unit 640 of the electronic device 600. For example, the content message display request may be a gesture moving from an upper portion of a bezel to the display unit 640 or a gesture moving from a lower portion of a bezel to the display unit 640. The user may view the content message, and select a desired application action.

In operation 740, the processor 610 may detect whether the application action is selected. When the application action is not selected, the processor 610 may store the content message in the storage unit 660 in operation 750. The processor 610 may periodically notify the user of a content message, which is not confirmed by the user. Otherwise, when there is no identified application action in relation to the content message, the processor 610 may execute the selected application. For example, the selected application is an application for display, so that when an image is included in the content message, the selected application may be an “image viewer”. The selected application may be selected by the user or also be selected by the electronic device 600.

When the application action is selected, the processor 610 may execute the selected application action in operation 760. For example, in a case of the “execution” among the application actions, the processor 610 may control an icon for a pre-selected application to be displayed on the display unit 640. The pre-selected application may be at least one of the applications executable based on the information included in the content message, the application installed in the electronic device 600, and the user's application use pattern. Accordingly, when the icon is selected, the processor 610 may automatically execute the selected application.

Otherwise, when the “storage” is selected among the application actions, the processor 610 may register the content message in at least one executable application. Otherwise, the processor 610 may receive a selection of an application to be stored in relation to the content message and register the content message in the selected application. Otherwise, the processor 610 may also store the content message in the storage unit 660 as it is.

Otherwise, when the “edit” is selected among the application actions, the processor 610 may receive a user input through the input unit 650. The user input may be a memo for the content message or setting a notification period. For example, when the content message is related to a “coupon”, the user may set a notification period so that the existence of a coupon is notified once a day or once a week by a termination date of the coupon.

Otherwise, when the “sharing” is selected among the application actions, the processor 610 may control at least one executable application to be displayed on the display unit 640. The executable application may be provided in a list form. When the executable application is provided in the list form, the processor 610 may display the most frequently used application considering the use pattern at a higher side.

Otherwise, when the “copy” is selected among the application actions, the processor 610 may execute the selected application. For example, the processor 610 may automatically execute a memo application. Otherwise, when the “deletion” is selected among the application actions, the processor 610 may delete the content message. Otherwise, when the “read later” is selected among the application actions, the processor 610 may maintain the content message in an area, in which the content message is displayed.

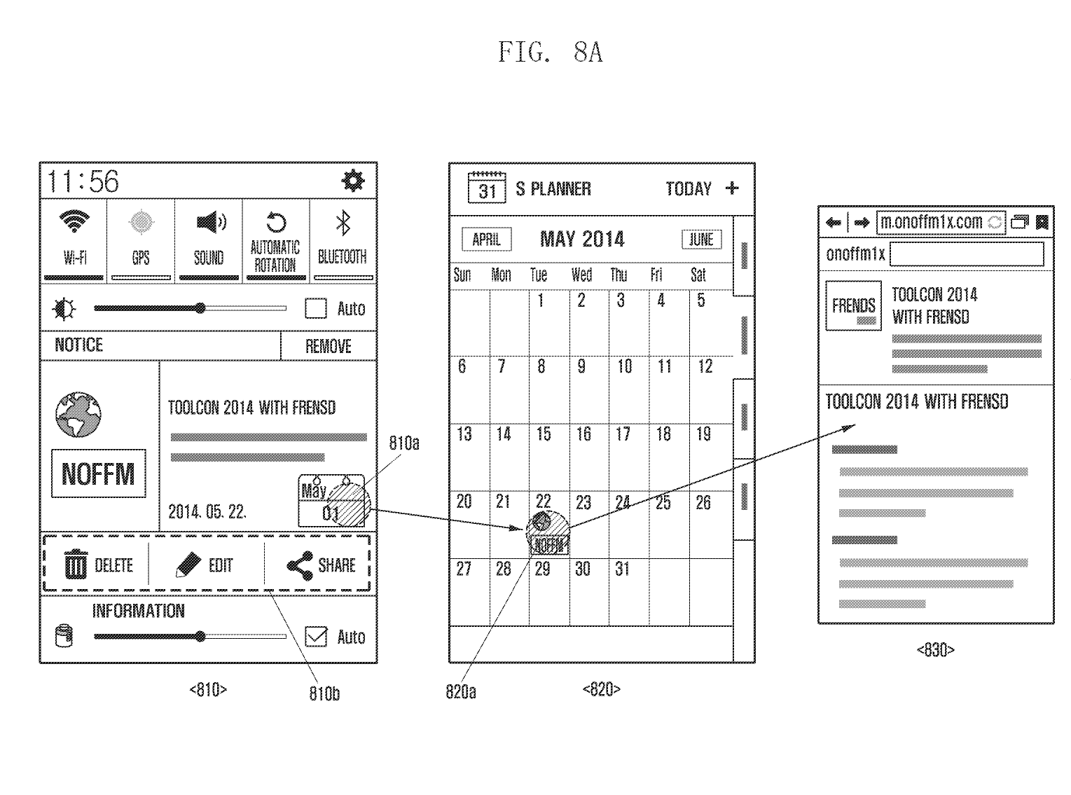

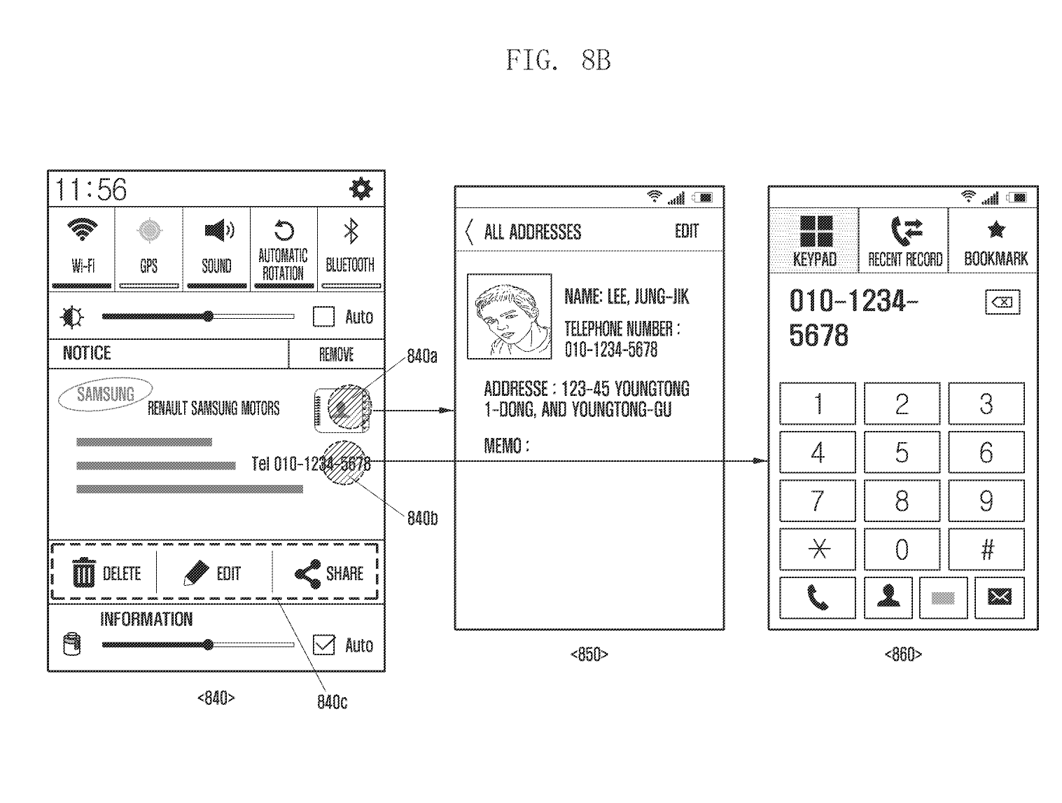

FIGS. 8A and 8B are diagrams illustrating a content message according to various embodiments of the present disclosure.

Referring to FIG. 8A, reference numeral 810 is an example of displaying a content message related to a “schedule”. Information in the content message 810 is weather, contents, and a place, and may be related to a “schedule”. The processor 610 may identify an application action related to the content message 810 based on at least one of information included in the content message, an application installed in the electronic device 600, and a user's application use pattern. The processor 610 may display application actions 810a and 810b together with the content message 810. The application action 810b may be storage, edit, sharing, copy, deletion, read later, and the like. The application action 810a is related to “execution”, and an icon for the selected application may be displayed. The content message 810 is related to the “schedule”, so that reference numeral 810a is an icon for a calendar application. When reference numeral 810a is selected, the processor 610 may execute the calendar application and display the executed calendar application on a screen as denoted by reference numeral 820. In this case, the processor 610 may automatically register information included in the content message 810 in the calendar application. For example, the processor 610 may register the information included in the content message 810 on May 22, 2014 as denoted by reference numeral 820a.

Further, the processor 610 may identify a browser application, a map application, and the like as applications, with which the content message 810 for the “schedule” is to be shared. When a date (May 22, 2014) is selected by the user, the processor 610 may display detailed information on a schedule registered in the date as denoted by reference numeral 830. When the detailed information is displayed, the processor 610 may display detailed information within a browser application by automatically executing the browser application. Otherwise, when the application action “sharing” is selected, the processor 610 may display an application list including a calendar application, a browser application, and a map application. Since there is a high possibility in that the user checks a predetermined place through the map application, the processor 610 may enable the map application to be shared.

Referring to FIG. 8B, reference numeral 840 is an example of a display of a content message related to a “business card”. Information included in a content message 840 is a name, a telephone number, and an address, and may be related to the business card. In this case, the processor 610 may identify an address book, a messenger, a call, a map application, and the like as an application to share the content message 840 for the “business card”. An application action 840c may b, for example, storage, edit, sharing, copy, deletion, and read later. An application action 840a is related to “execution”, and the processor 610 may control an icon for an address book application to be displayed. When reference numeral 840a is selected, the processor 610 may execute the address book application and display the executed address book application on the screen as denoted by reference numeral 850. In this case, the processor 610 may automatically register a name (LEE, Jung-Jik), a telephone number (010-1234-5678), and an address (123-456 Youngtong 1-dong, and Youngtong-gu) included in the content message 840 in an address book.

Further, when the telephone number 010-1234-5678 within the content message 840 is selected as denoted by reference numeral 840b, the processor 610 may execute a call application and display the executed call application on the screen as denoted by reference numeral 860. In this case, the processor 610 may automatically input the selected telephone number 010-1234-5678 into the call application and display the telephone number. Otherwise, when the application action “sharing” is selected, the processor 610 may display an application list including the address book the messenger, the call, and the map application. Since there is a high possibility in that the user checks an address through the map application, the processor 610 may enable the map application to be shared.

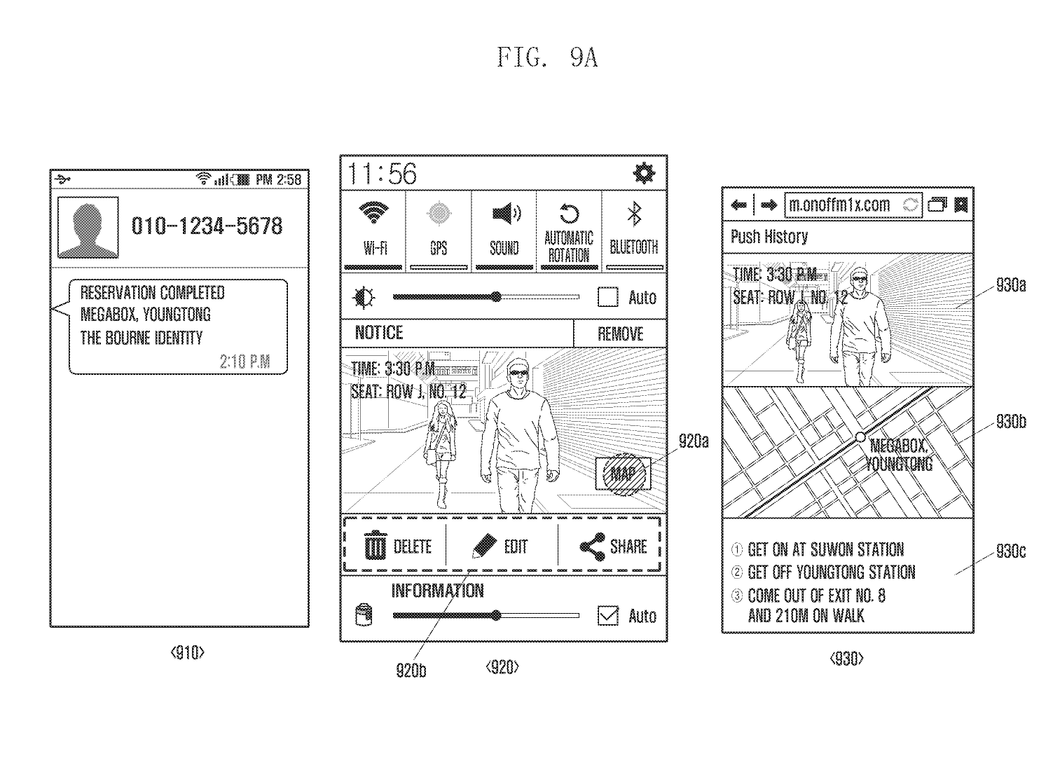

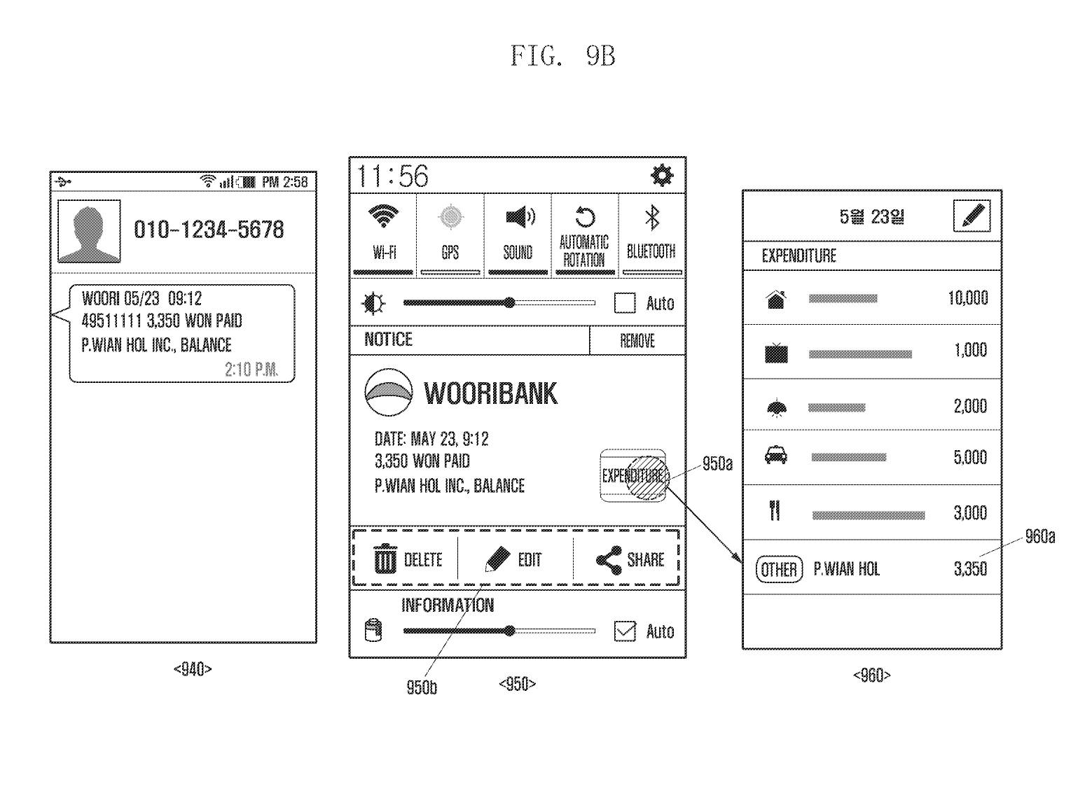

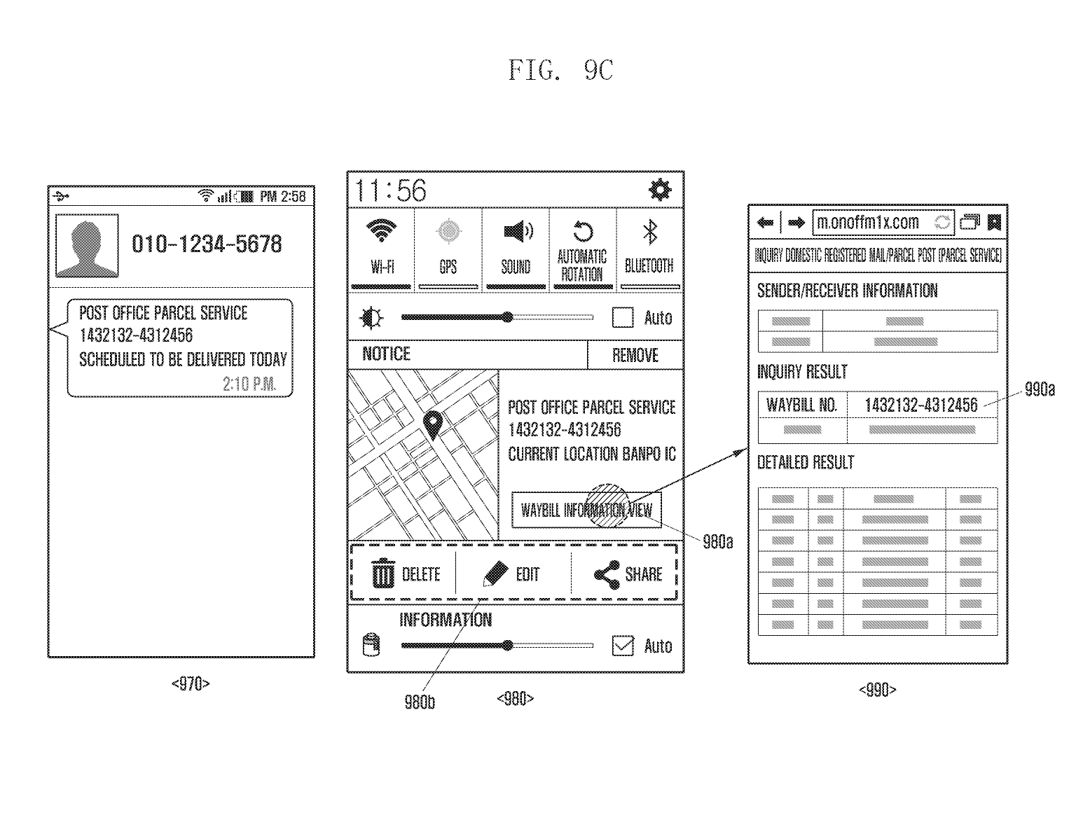

FIGS. 9A to 9C are diagrams illustrating generation and display of a content message by using a push message according to various embodiments of the present disclosure.

Referring to FIG. 9A, reference numeral 910 illustrates a push message, and reference numeral 920 of FIG. 9A illustrates a content message. A message type of the push message 910 is a text type, so that the message processing server 300 may determine a template based on the text type, and generate a content message 920 by applying information (place: Megabox, Youngtong, Movie title: Godzilla, 3D) included in the push message 910 to the template. According to the template, an image is inserted into a background, and text is included on the image. Accordingly, in the content message 920, a movie image is displayed on the background, and movie information (Time; 3:30 p.m. Seat: Row J, No. 12) is displayed on the movie image.

The electronic device 600 may identify an application action related to the content message 920. The electronic device 600 may display an icon for the map application 920a and an application action 920b, such as storage, edit, sharing, and read later, together with the content message 920 based on the identified application action. When reference numeral 920a is selected, the processor 610 may execute the map application and display the executed map application on the screen as denoted by reference numeral 930. In this case, the electronic device 600 may display a content message 930a, display a map image for a place of a movie theater as denoted by reference numeral 930b, and display navigation information for navigating to the movie theater based on a current location as denoted by reference numeral 930c.

Referring to FIG. 9B, reference numeral 940 illustrates a push message, and reference numeral 950 of FIG. 9B illustrates a content message. A message type of the push message 940 may be a predetermined type or a text type. For example, the message processing server 300 may confirm that the message type of the push message 940 is the text type, determine a template based on the text type, and generate the content message 950 by applying information (Wooribank, 5/23 09: 12, 49511111 3,350 won paid) included in the push message 940 to the template. According to the template, an image, which is a bank logo, is included in a part of an upper area, and text (date: May, 23, 9:12, 3,350 won paid) is included in a lower area. Accordingly, in the content message 950, the bank logo image is displayed at a part of an upper area, and payment details (date: May, 23, 9:12, 3,350 won paid) are displayed in a lower area.

The electronic device 600 may identify an application action related to the content message 950. The electronic device 600 may display an icon for a housekeeping book 950a and an application action 950b, such as storage, edit, sharing, and read later, together with the content message 950 based on the identified application action. When reference numeral 950a is selected, the electronic device 600 may execute the housekeeping book application and display the executed housekeeping book application on the screen as denoted by reference numeral 960. In this case, the electronic device 600 may automatically register payment details 960a in the housekeeping application.

Referring to FIG. 9C, reference numeral 970 illustrates a push message, and reference numeral 980 of FIG. 9C illustrates a content message. A message type of the push message 970 may be a text type. The message processing server 300 may determine a template based on the text type, and generate a content message 980 by applying information (post office parcel service 1432132-4312456 schedule to be delivered today) included in the push message 970 to the template. According to the template, an image is inserted in a left area, and text (post office parcel service 1432132-4312456 scheduled to be delivered today) is included in a right area. Accordingly, in the content message 980, a map image may be displayed in a left area, and delivery information (post office parcel service 1432132-4312456, current location: Banpo IC) may be displayed in the right area.

The electronic device 600 may identify an application action related to the content message 980. The electronic device 600 may display an icon 980a for a post office application and an application action 980b, such as storage, edit, sharing, and read later, together with the content message 980 based on the identified application action. When reference numeral 980a is selected, the electronic device 600 may execute the post office application and display the executed post office application on the screen as denoted by reference numeral 990. In this case, the electronic device 600 may register a waybill number 1432132-4312456 as denoted by reference numeral 990a in the post office application.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An apparatus for processing a message, the apparatus comprising:
a message controller configured to:
check contents included in a push message,
determine a template of the push message in relation to the contents, and
generate a content message by using the contents and the template; and
a message communication unit configured to:
receive the push message from a service server, and
transmit the content message to an electronic device.

2. The apparatus of claim 1, further comprising:
a message type database configured to store information for analyzing the contents,
wherein the message controller is further configured to confirm that the contents are at least one of an image, a uniform resource locator (URL), a map, a schedule, and a text with reference to the message type database.

3. The apparatus of claim 2, wherein the message controller is further configured to:
parse application information from the push message, and
apply the parsed application information to the template to generate the content message.

4. The apparatus of claim 1, wherein the message controller is further configured to:
assign a server identifier to the service server according to a request from the service server,
assign a device identifier to the electronic device according to a request from the electronic device, and
store the server identifier and the device identifier in an identifier database.

5. The apparatus of claim 4, further comprising:
a validity confirming unit configured to:
determine whether a server identifier and a device identifier included in the push message are the same as those stored in the identifier database, and
confirm validity of the push message.

6. An electronic device comprising:
a display unit configured to display a content message; and
a processor configured to:
identify an application action related to the content message,
control the content message and the identified application action to be displayed on the display unit, and
execute an application action selected by a user.

7. The electronic device of claim 6, wherein the processor is further configured to identify the application action based on at least one of information included in the content message, an application installed in the electronic device, and a user's application use pattern.

8. The electronic device of claim 7, wherein the application action includes at least one of execution, storage, edit, sharing, copy, delete, and read later.

9. The electronic device of claim 8, wherein, when the sharing application action is selected from among the application actions, the processor is further configured to control one or more executable applications to be displayed on the display unit.

10. The electronic device of claim 8, wherein, when the storage application action is selected from among the application actions, the processor is further configured to register the content message in one or more executable applications.

11. The electronic device of claim 6, wherein the processor is further configured to:
confirm contents included in the content message,
determine a template related to the contents, and
generate the content message based on the contents and the template.

12. A method of processing a message by a message processing apparatus, the method comprising:
checking contents included in a push message received from a service server;
determining a template of the push message based on the contents;
generating a content message by using the contents and the template; and
transmitting the content message to an electronic device.

13. The method of claim 12, further comprising:
storing information for analyzing the contents in a message type database,
wherein checking includes checking the contents using the message type database.

14. The method of claim 13, wherein the generating includes:
parsing application information from the push message; and
generating the content message by applying the parsed application information to the template.

15. The method of claim 12, further comprising:
assigning a server identifier to the service server according to a request from the service server;
assigning a device identifier to the electronic device according to a request from the electronic device; and
storing the assigned server identifier and the device identifier in an identifier database.

16. The method of claim 15, further comprising:
determining whether a server identifier and a device identifier included in the push message are the same as those stored in the identifier database; and
confirming validity of the push message according to the determination result.

17. A method of processing a message by an electronic apparatus, the method comprising:
identifying an application action related to a content message;
displaying the content message and the identified application action; and
executing an application action selected by a user.

18. The method of claim 17, wherein the identifying of the application action includes identifying the application action based on at least one of information included in the content message, an application installed in the electronic device, and a user application use pattern.

19. The method of claim 18, wherein the application action includes at least one of execution, storage, edit, sharing, copy, delete, and read later.

20. The method of claim 17, wherein the content message is received from a service server or generated by using a template related to contents included in the content message by the electronic apparatus.
